(19) United States
(12) Patent Application Publication
(10) Pub. No.: US 2026/0225553 A1
(43) Pub. Date: Aug. 6, 2026

(54) SEAT BACK

(71) Applicant: TOYOTA BOSHOKU KABUSHIKI KAISHA, Aichi-ken (JP)

(72) Inventor: Masahiko IYODA, Aichi-ken (JP)

(73) Assignee: TOYOTA BOSHOKU KABUSHIKI KAISHA, Aichi-ken (JP)

(21) Appl. No.: 19/454,775

(22) Filed: Jan. 21, 2026

(30) Foreign Application Priority Data
Feb. 6, 2025 (JP) 2025-018389

(51) Int. Cl. B60R 21/207; B60N 2/64

(52) U.S. Cl. CPC B60R 21/207; B60N 2/64

(57) ABSTRACT

A seat back has a frame and a member attached to the frame and configured to support a seater. The member includes a main member located at a central portion in a seat width direction and two side members located on both sides of the main member. Each of the side members has a side support member. A side support member of at least one of the two side members includes an airbag device that inflates forward thereof. The side support member of the side member in which the airbag device is disposed is provided with a through-hole through which the airbag device passes inward when the airbag device is attached to the frame. An extension portion having a locking portion configured to engage with a bracket that supports a headrest support mounted to the frame is formed on an upper portion of the side support member.

### CROSS-REFERENCE TO RELATED APPLICATION

This application claims priority to Japanese patent application serial number 2025-18389 filed Feb. 6, 2025, the contents of which are incorporated herein by reference in its entirety for all purposes.

### TECHNICAL FIELD

The present disclosure relates to a seat back. In particular, the present disclosure relates to a seat back with an airbag device installed inside.

### BACKGROUND

A seat back for a vehicle seat, such as an automobile, commonly features a seat back pad divided into three parts along the seat's width, which are assembled onto a seat back frame. For example, a prior art discloses a seat back having a seat back main member, which is the central portion in the seat width direction, and two seat back side members, which are located on both sides of the seat back main member. Each of these is attached to a seat back frame separately. Such a vehicle seat has good ease of assembly and is easily compatible with automation of assembly. In addition, it is easy to replace only the seat back side member, which tends to deteriorate when a seater gets on and off.

According to the vehicle seat described in the above prior art, when attempting to mount an airbag device in a seatback, it is difficult to assemble the seatback side member to the seatback frame in a state in which the airbag device is attached to the seatback frame.

Therefore, there emerged a need for a seat back designed where a seat divided into three sections in the seat width direction could be assembled to a frame. The seat back allows an attachment of an airbag device without impeding airbag's deployment.

### SUMMARY

A first aspect of the present disclosure is a seat back, which comprises a frame that forms a framework and a member attached to the frame and configured to support a seater. The member comprises a main member located at a central portion in a seat width direction and two side members located on both sides of the main member. Each of the side members comprises a side support member. A side support member of at least one of the two side members includes an airbag device that inflates forward thereof. The side support member of the side member in which the airbag device is disposed is provided with a through-hole through which the airbag device passes inward when the airbag device is attached to the frame. An extension portion having a locking portion configured to engage with a bracket that supports a headrest support mounted to the frame is formed on an upper portion of the side support member.

### BRIEF DESCRIPTION OF DRAWINGS

FIG. 1 is a perspective view of an automobile seat to which a seat back according to one embodiment is assembled.

FIG. 2 is an exploded perspective view of the seat back of FIG. 1.

FIG. 3 is a front view of the seat back of FIG. 1 showing only a right side, as the shape of the seat back is symmetrical to the right and left. A frame and a side support member of a side member are shown.

FIG. 4 is a cross-sectional view taken along a line IV-IV in FIG. 3 showing a back pad and a back cover of the side member, and a main member.

FIG. 5 is a cross-sectional view taken along a line V-V in FIG. 3 showing the back pad and the back cover of the side member, and the main member.

FIG. 6 is a perspective view of the side support member and the upper part of the frame.

FIG. 7 is a top plan view of the side support member and the upper part of the frame.

### DETAILED DESCRIPTION

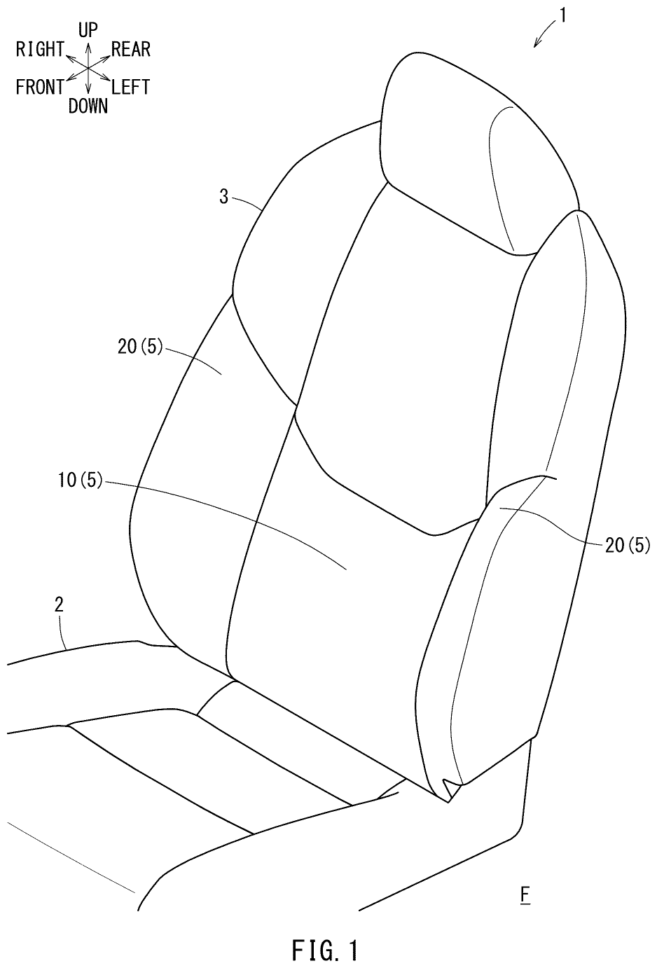

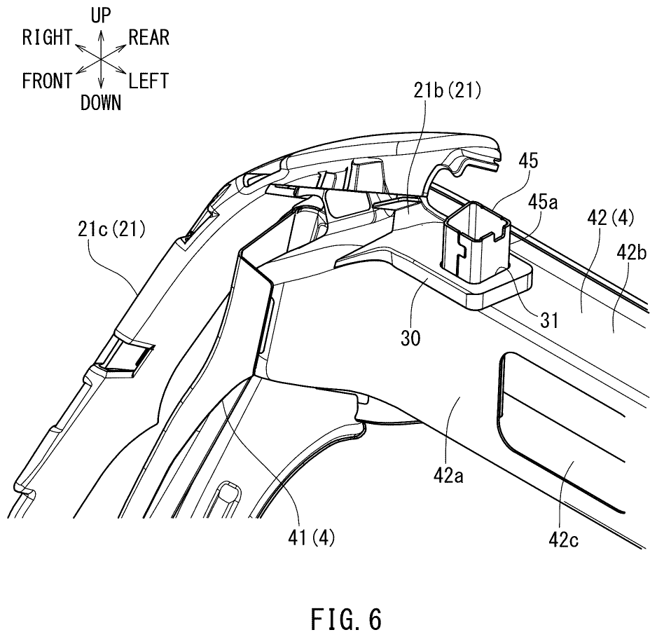

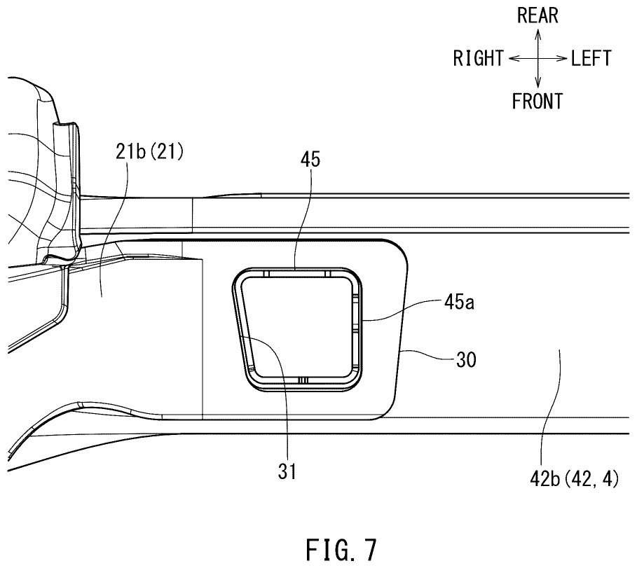

Referring to FIGS. 1 to 7, a seat back 3 of an automobile seat 1 is described in detail. In the following description, explanations regarding the directions shall be based on the respective directions of up/down, front/rear, right/left as shown in each figure. Here, the up/down, front/rear, right/left directions are defined based on the automobile seat 1 when it is mounted on a floor F of the automobile. The right-left direction corresponds to a seat width direction (horizontal direction).

As shown in FIG. 1, the automobile seat 1 has a seat cushion 2 that supports the seater's buttocks and thighs, and a seat back 3 that supports the seater's waist and back.

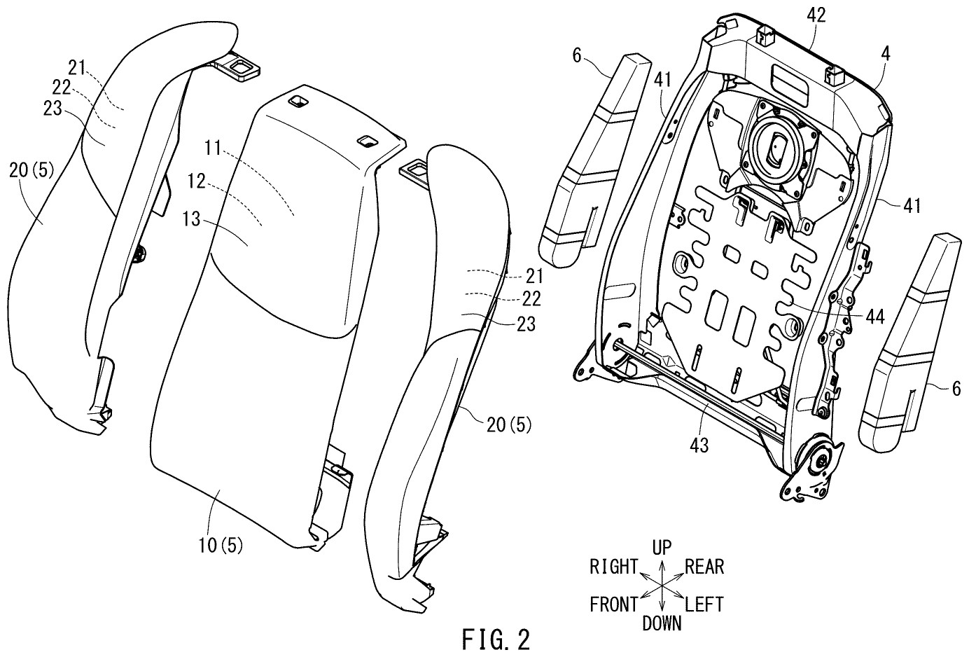

As shown in FIGS. 1 and 2, the seat back 3 has a frame 4 that forms a structural framework, a member 5, which is attached to the frame 4 and provides cushioning while defining the external shape of the seat back 3, and a pair of airbag devices 6 located on the right and left sides.

As shown in FIGS. 1 and 2, the frame 4 forms the structural framework of the seat back 3 and is rectangular when viewed from the front. The frame 4 has a pair of side frames 41, an upper frame 42, and a lower frame 43. The side frames 41 vertically supports on the right and left sides of the seat back 3. The upper frame 42 connects the upper ends of the side frames 41. The lower frame 43 connects the lower ends of the side frames 41. A lumbar plate 44 is positioned between the upper frame 42 and the lower frame 43.

As shown in FIGS. 2, 3, 6, and 7, the upper frame 42 has a hat-shaped cross-section that opens toward the rear. The upper frame 42 includes a front surface portion 42a that faces forward, an upper surface portion 42b that is positioned at the top, and a lower surface portion 42c that is positioned at the bottom. A square tubular bracket 45 is disposed between the upper surface portion 42b and the lower surface portion 42c to support a headrest support 7, through which a headrest stay (not shown) passes. The bracket 45 vertically penetrates the upper surface portion 42b and the lower surface portion 42c, and a portion of the bracket protruding upward from the upper surface portion 42b to form an upper protruding portion 45a.

As shown in FIGS. 1 to 4, the member 5 is attached to the frame 4 and is divided into a main member 10 located at the central portion in the seat width direction and a pair of side members 20 that is positioned on both sides of the main member 10. The main member 10 supports the waist and back of the seater from the rear side. The side members 20 support the waist and back of the seater from the side.

The main member 10 has a main support member 11, a main pad 12, and a main cover 13. The main support member 11 provides structural supports and is made of resin. The main pad 12 is a cushioning body made of elastic material, such as polyurethane foam, and disposed on the front side of the main support member 11 and supported by the main support member 11 against the frame 4. The main cover 13 covers the main pad 12 from the front side and is bag shaped and sewn from multiple pieces, with its opening engaged with the outer edge of the main support member 11.

The rear surface of the upper part of the main support member 11 is fixed to the upper frame 42. The rear surface of the main support member 11 is fixed to the lumbar plate 44 at approximately the center in a vertical direction. The rear surface of the lower part of the main support member 11 is fixed to the lower frame 43.

The main pad 12 is typically made of an elastic body, often a foam molded body of polyurethane resin, which offers both cushioning and durability. The main pad 12 has approximately the same external shape as the main support member 11 when viewed from the front. The main cover 13 is formed by sewing multiple pieces. The main cover 13 is a bag-shaped that opens rearwardly. The main cover 13 covers the main pad 12, which is arranged on the front side of the main support member 11, from the front side. The end portion of the opening of the main cover 13 is then engaged with the outer peripheral part of the main support member 11, thereby the main member 10 is formed.

As shown in FIGS. 2 to 4, each side member 20 has a side support member 21, a side pad 22, and a side cover 23. The side support member 21 provides structural support to the side pad 22 against the frame 4 and is made of resin. The side support member 21 features a through-hole 21a to accommodate the airbag device and is a deforming portion with a substantially U-shaped cross section opening rearwardly. The side pad 22 is a cushioning body positioned in front of the side support member 21. The side pad 22 is supported by the side support member 21 against the frame 4. The side cover 23 covers the side pad 22 from the front side. The side members 20 have symmetrical shapes, so the right side member 20 will be described as a representative example.

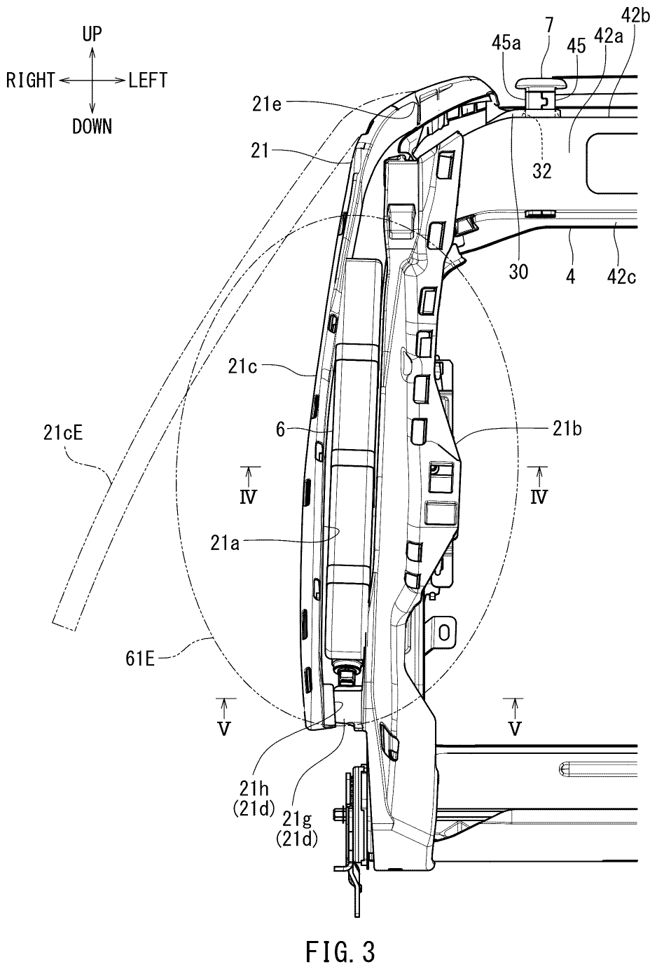

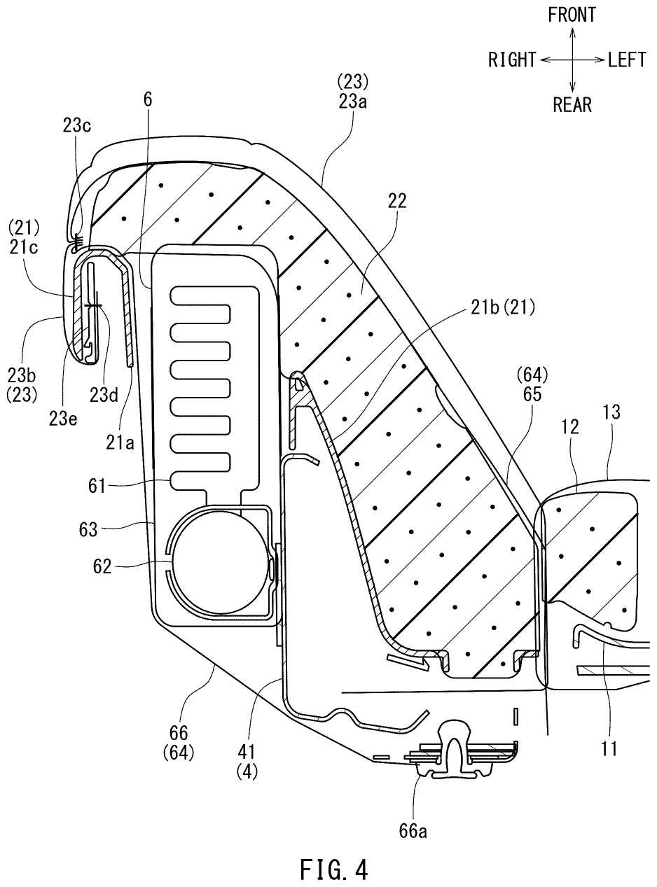

As shown in FIG. 3, the side support member 21 extends vertically. A through-hole 21a is formed in the center area in a right-left direction of the side support member 21. The through-hole 21a extends in the vertical direction and penetrates in a front-rear direction. The left side of the through-hole 21a (inside the seat) is a base portion 21b extending vertically along the front side of the side frame 41. The right side of the through-hole 21a (outside the seat) is a deforming portion 21c. The shape of the horizontal cross section of the deforming portion 21c is substantially U-shape opening rearwardly (see FIG. 4). A weakened portion 21d is formed at the lower part of the through-hole 21a. The lower end of the base portion 21b and the lower end of the deforming portion 21c are connected via the weakened portion 21d. The upper end of the base portion 21b and the upper end of the deforming portion 21c are connected, allowing the upper end of the deforming portion 21c gradually curves to the left (inwardly toward the seat) as it moves upward against the upper end of the base portion 21b. On the upper part of the through-hole 21a, an R-portion 21e, which has an R-shape viewed from the front, is formed between the base portion 21b and the deforming portion 21c. An extension portion 30 extending toward the left (toward the inside of the seat) is provided at the upper end of the base portion 21b.

As shown in FIGS. 3, 6, and 7, the extension portion 30 is formed as a plate-like member that extends upward and contacts the upper surface portion 42b of the upper frame 42. An opening 31 is formed at the distal end side of the extension portion 30, the opening extending in the vertical direction, allowing an upper protruding portion 45a of the bracket 45 to pass through. The thickness of the extension portion 30 is set to be approximately three times the thickness of a general portion of the base portion 21b. The side support member 21 is fixed to the frame 4 via a rear surface portion (not shown) located approximately at the vertical center of the base portion 21b, the extension portion 30, and a weakened portion 21d. A tapered surface portion 32, which is a chamfered surface, is formed on a wall surface portion of the opening 31 to facilitate insertion of the upper protruding portion 45a into the opening 31 when the extension portion 30 is moved toward the upper protruding portion 45a from above. Here, the opening 31 corresponds to the “locking portion” as recited in the claims.

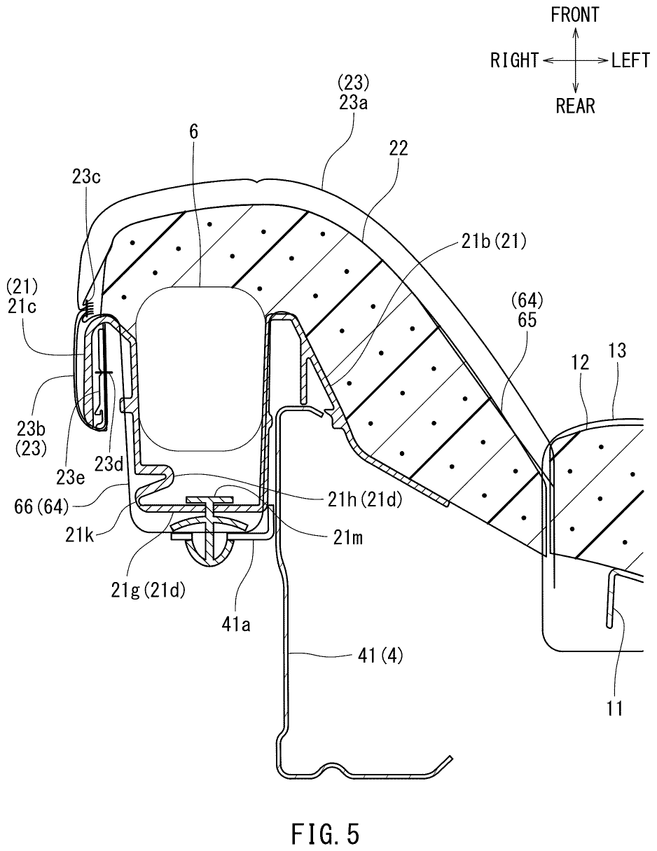

As shown in FIGS. 3 and 5, the weakened portion 21d has a rectangular attaching portion 21g (when viewed from the front) and a bending portion 21h with a Z-shaped cross-section in the horizontal plane. The front end of the bending portion 21h connects to the deforming portion 21c, while the rear end of the bending portion 21h joins the right side of the attaching portion 21g. An outer bending portion 21k, which is the bending area on the seat's outer (right) of the bending portion 21h, has a thinner wall thickness. When a load is applied to the deforming portion 21c in the rightward (outward) direction during the airbag deployment, the weakened portion 21d is ruptured. The attaching portion 21g is secured to a bracket 41a of the side frame 41 using a clip 21m inserted through a clip hole (not shown).

FIGS. 2, 4, and 5 illustrate the side pad 22, which, from a front view, mirrors the external shape of the side support member 21. The side pad 22 is an elastic cushion body, foam molded from polyurethane resin, positioned in front of the side support member. The side pad 22 is formed to cover the front surface of the airbag device 6. The side pad 22 does not have a through-hole penetrated in the front-rear direction, which corresponds to the through-hole 21a. The side cover 23 is a bag-shaped formed by sewing multiple pieces, which covers the side pad 22 from the front side of the side support member 21. The opening end of the side cover 23 is then fastened to the outer peripheral part of the side support member 21, thereby the side member 20 is formed. As shown in FIG. 4, the side cover 23 has a first cover portion 23a, which covers the front and left sides of the side pad 22, and a second cover portion 23b, which covers the right side of the side support member 21. The right end of the first cover portion 23a and the right front end of the second cover portion 23b are connected by a first sewing portion 23c.

The airbag device 6 is housed within the side support member 21 and assembled to the outer surface of the side frames 41. Since the right and left airbag devices 6 have abbreviated symmetrical shape, the airbag device 6 on the right side will be described. As shown in FIGS. 2 to 5, the airbag device 6 is formed in a vertically long box shape. The external shape of the airbag device 6 roughly matches the shape of the through-hole 21a of the side support member 21 when viewed from the front. The airbag device 6 has an airbag 61 that inflates forward upon activation, an inflator 62 that injects gas into the airbag 61 during deployment upon receiving a collision signal from the vehicle's ECU (not shown), a case 63 that is a vertical-shaped container that houses the airbag 61 and inflator 62, and a stay cloth 64 that guides the deployment direction of the airbag 61.

The left side surface of the case 63 is fixed to the side frame 41. When the airbag 61 inflates, the case 63 opens through a slit (not shown) during the airbag 61 deploys to the front of the seat.

The stay cloth 64 is a stretch-resistant guide cloth that guides the deployment direction of the airbag 61. The stay cloth 64 includes a front stay cloth 65 positioned on the front side of the air bag and a rear stay cloth 66 positioned on the rear side of the air bag61. The right end of the front stay cloth 65, the right end of the first cover portion 23a, the right front end of the second cover portion 23b, and the right end of the rear stay cloth 66 are overlapped in this order and sewn together at the first sewing portion 23c. The left front end of the second cover portion 23b is sewn with a resin plate 23e by a second sewing portion 23d. The resin plate 23e is arranged on the inner side of the U-shaped deforming portion 21c of the side support member 21. Thereby, the right side of the side cover 23 is fixed to the side support member 21. The left end of the front stay cloth 65 is fixed to the frame 4 by a fixing member (not shown). The left end of the rear stay cloth 66 is fixed to the frame 4 by a fixing member 66a.

The assembly procedure of the seat back 3 involves the following steps. First, as shown in FIGS. 3 to 5, the airbag device 6 is attached to the outer side of each side frame 41. Then, the pre-assembled right and left side members 20 are assembled to the frame 4. At this time, the airbag device 6 is arranged inside the side member 20 by passing the airbag device 6 through the through-hole 21a of the side support member 21. Then, the left end of the front stay cloth 65 is fixed to the frame 4 by the fixing member (not shown). Then, the left end of the rear stay cloth 66 is fixed to the frame 4 by the fixing member 66a. Next, the main member 10 is assembled to the frame 4. Finally, a backboard (not shown) is attached to the rear side of the frame 4 to conceal inside. When removing the main member 10 and each side member 20 from the frame 4, the procedure is the reverse of the above procedure.

As shown in FIG. 1, the assembled seat back 3 is secured to floor F after attachment to the seat cushion 2 to form the automobile seat1. Upon receiving a collision signal from vehicle's ECU, the airbag device 61 activates the inflator 62 to inject gas into the airbag 61, causing it to inflate forward. This inflation, in the process of the airbag 61 expanding to a deployed state 61E, ruptures the outer bending portion 21k (see FIG. 5) of the weakened portion 21d, which results in the deforming portion 21c of the side support member 21 rotating toward the right direction into a deformed state 21cE (see FIG. 3). As a result, the deforming portion 21c of the side support member 21 turns around its upper end toward the right direction to become a deformed state 21cE. Consequently, the tensile force from the front stay cloth 65 and the rear stay cloth 66 rupture the first sewing portion 23c, allowing the airbag 61 to deploy forward from between the first cover portion 23a and the second cover portion 23b.

The described embodiments offer several advantages. The side support member 21 has the through-hole 21a with a weakened portion 21d at its lower edge. When the air bag 61 deploys, the deployment pressure ruptures the weakened portion 21d, allowing the through-hole 21a to expand outward in the seat width direction. The shape of the through-hole 21a corresponds to the external shape of the airbag device 6 (when viewed from the front). This enables the side member 20 to be attached to the side frame 41 while the airbag device 6 is already secured to the side frame 41, effectively housing the airbag device 6 within the side member 20. Upon deployment, the airbag 61 can inflate unimpeded by the side support member 21. Furthermore, the upper portion of the side support member 21 is formed with an extension portion 30 having the opening 31. The upper protruding portion 45a of the bracket 45 mounted to the frame 4 is inserted into the opening 31. This arrangement suppresses detachment of the side support member 21 from the frame 4. Accordingly, during deployment of the airbag 61, only the weakened portion 21d of the side support member 21 ruptures, which prevents the sharp edge portion of the side support member 21 from being exposed externally. The airbag device 6 can be attached to a separate-type seat back 3 with a main member 10 and each side member 20 without reducing the functionality of the airbag device 6.

The side member 20 comprises a side pad 22 as a cushion body and a side cover 23 that covers the side pad 22. The side support member 21 provides planar surface support to the side pad 22 on the side facing the frame 4. This arrangement facilitates the above-mentioned effects in the seat back 3 that has cushioning properties and decorativeness.

The bracket 45 has a rectangular tubular shape, and the extension portion 30 is formed with a through-hole 21a through which the upper protruding portion 45a of the bracket 45 passes. This configuration enables the side support member 21 to be effectively prevented from detaching from the frame 4 upon activation of the airbag device 6, while maintaining a simple structure.

The thickness of the extension portion 30 is set to be approximately three times the thickness of a general portion of the side support member 21. This configuration allows the strength of the extension portion 30 to be easily increased, thereby effectively preventing the side support member 21 from detaching from the frame 4 when the airbag device 6 is activated.

The tapered surface portion 32 is formed on the outer peripheral edge of the through-hole 21a in the extension portion 30 to facilitate the insertion of the bracket 45 into the through-hole 21a. This configuration makes facilitates the attachment of the side support member 21 to the frame 4.

Another aspect of the present disclosure relates to the seat back, wherein the member is configured to elastically support the seater. The main member comprises a main pad, a main cover for covering the main pad, and a main support member attached to a frame side of the main pad for supporting the main pad. The side member comprises a side pad and a side cover for enclosing the side pad. The side support member provides planar surface support to the side pad on the side facing the frame.

According to the above aspect, it is possible to achieve the effects of the first aspect in the seat back that has cushioning properties and decorativeness.

Another aspect of the present disclosure relates to the seat back, wherein the bracket has a square tubular shape and the locking portion of the extension portion is a rectangular opening through which the bracket passes.

According to the above aspect, it is possible the side support member to be effectively prevented from detaching from the frame upon activation of the airbag device, while maintaining a simple structure.

Another aspect of the present disclosure relates to the seat back, wherein the thickness of the extension portion is set to be approximately three times the thickness of a general portion of the side support portion.

According to the above aspect, the strength of the extension portion can be easily increased, thereby the side support member can be effectively prevented from coming off the frame when the airbag device is deployed.

Another aspect of the present disclosure relates to the seat back, wherein a tapered surface is formed on the outer peripheral edge of the opening in the extension portion to facilitate insertion of the bracket into the through-hole.

According to the above aspect, the work of attaching the side support member to the frame can be facilitated.

Although certain embodiments have been described above, the present disclosure is not limited to these appearances and configuration, and various changes, additions, and deletions are possible to the extent that do not alter the gist of the invention. For example, the following are examples.

According to the above embodiments, the airbag devices 6 are arranged on both the right and left sides. However, the airbag device 6 may be arranged on only one of the right and left sides.

According to the above embodiments, the opening 31 is formed as a hole having a rectangular cross-sectional shape. However, the opening is not limited to this configuration and may instead be formed as a portion of the outer peripheral surface that is partially open to the outside.

According to the above embodiments, the present disclosure is applied to the seat back 3 of the automobile seat 1, but may also be applied to a seat of a railway vehicle.

The various examples described above in detail with reference to the attached drawings are intended to be representative of the present disclosure and are thus non-limiting embodiments. The detailed description is intended to teach a person of skill in the art to make, use and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved seat back, and/or methods of making and using the same.

What is claimed is:

1. A seat back comprising:
a frame forming a framework; and
a member attached to the frame and configured to elastically support a seated occupant, wherein the member comprises:
a main member located at a central portion in a seat width direction; and two side members located on both sides of the main member,
wherein:
each of the side members comprises a side support member;
at least one of the two side members is provided with an airbag device disposed therein and configured to deploy forward;
the side support member of the side member in which the airbag device is disposed is formed with a through-hole through which the airbag device passes inward in a state where the airbag device is mounted to the frame; and
an upper part of the side support member is formed with an extension portion having an engaged portion engageable with a bracket that supports a headrest support attached to the frame.

2. The seat back of claim 1, wherein the main member comprises a main pad, a main cover for covering the main pad, and a main support member attached to a frame side of the main pad and configured to support the main pad in a planar manner.

3. The seat back of claim 1, wherein the locking portion of the extension portion is a rectangular opening through which a bracket that supports a headrest support mounted to the frame passes.

4. The seat back of claim 1, wherein the thickness of the extension portion is set to be approximately three times the thickness of a general portion of the side support portion.

5. The seat back of claim 3, wherein a tapered surface is formed on an outer peripheral edge of the rectangular opening in the extension portion to facilitate insertion of the bracket into the through-hole.

6. The seat back of claim 1, wherein the side member comprises a side pad and a side cover for enclosing the side pad, and the side support member supports, in a planar manner, the frame-facing side of the side pad.
